(19) United States
(12) Patent Application Publication
(10) Pub. No.: US 2017/0167711 A1
(43) Pub. Date: Jun. 15, 2017

(54) ILLUMINATION DEVICE

(71) Applicant: PHILIPS LIGHTING HOLDING B.V., EINDHOVEN (NL)

(72) Inventor: Simon Eme KADIJK, EINDHOVEN (NL)

(21) Appl. No.: 15/323,739

(22) PCT Filed: Jul. 4, 2015
(86) PCT No.: PCT/EP2015/065269

§ 371 Date: Jan. 4, 2017

(30) Foreign Application Priority Data
Jul. 4, 2014 (EP) 14175726.0
Jul. 8, 2014 (EP) 14176051.2

(51) Int. Cl. F21V 29/503; F21V 29/89; F21K 9/90; F21V 29/70

(52) U.S. Cl. CPC F21V 29/503; F21V 29/70; F21V 29/89; F21K 9/90; F21Y 2115/10

(57) ABSTRACT

An illumination device (100) is provided, comprising a light source (110), an envelope (120) adapted to at least partially enclose the light source, and a positioning member (130) adapted to position the light source within the envelope. The positioning member can be arranged to assume a first state in which the light source is positioned at a first distance (d₁) from an inner surface portion (123) of the envelope and a second state in which the light source is positioned at a second distance (d₂) from the inner surface portion. The positioning member comprises a shape-memory material adapted to shift the positioning member from the first state to the second state as the shape-memory material is exposed to an external stimulus such as a temperature or magnetic field exceeding a predetermined threshold value. Since the second distance is smaller than the first distance, the light source can be moved towards a wall of the envelope and hence the efficiency of heat dissipated from the light source via the envelope may be increased.

### FIELD OF THE INVENTION

The present invention generally relates to the field of illumination devices, in particular illumination devices comprising a positioning member for positioning a light source within an envelope, and a method of manufacturing such devices.

### BACKGROUND OF THE INVENTION

The optical performance and life length of solid state light sources, e.g. light emitting diodes (LEDs), are known to depend on e.g. their operating temperature. Too high operation temperatures increase the risk of degradation and reduced life time of the light sources. There is therefore a great interest in cooling and heat dissipation of light sources, especially high power LEDs and LEDs for replacement of traditional, energy consuming light sources, e.g. incandescent lamps. The generated heat may e.g. be dissipated by free convection to the surrounding atmosphere, and by heat conduction via e.g. a heat sink arranged in thermal contact with the light source.

In US 2013/0257261 an illumination apparatus is disclosed wherein a light source is cooled by a heat dissipation unit arranged beneath the light source. An adjustable gap is formed between the light source and the heat dissipation unit and can be controlled by a thermal deformation material such that the gap is reduced at higher temperatures. Thereby the cooling efficiency may be increased as the temperature of the light source rises.

Although different illumination devices and heat dissipation techniques are known, there is a need for compact illumination devices that are easy to manufacture and capable of adequately cooling the light source during operation.

### SUMMARY OF THE INVENTION

To better address one or more of the above mentioned concerns, an illumination device having the features defined in the independent claim, and a method for manufacturing such device, is provided. Preferable embodiments are defined in the dependent claims.

Hence, according to an aspect, an illumination device is provided, comprising a light source adapted to emit light, an envelope adapted to at least partially enclose the light source, and a positioning member adapted to position the light source within the envelope. The positioning member is arrangeable to assume a first state, in which the light source is positioned at a first distance from an inner surface portion of the envelope, and a second state in which the light source is positioned at a second distance from the inner surface portion, and wherein the second distance is smaller than the first distance. Furthermore, the positioning member comprises a shape-memory material that is adapted to shift or cause the positioning member to shift from the first state to the second state as the shape-memory material it is exposed to a trigger or an external stimulus.

According to a second aspect, a method for manufacturing an illumination device is provided. The method comprises the steps of arranging a positioning member within an envelope that is adapted to at least partly enclose a light source. The positioning member is adapted to position the light source at a first distance from an inner surface portion of the envelope. Further, the method comprises exposing a shape-memory material of the positioning member such that the shape-memory material shifts the positioning member to a second state in which the light source is positioned at a second distance from the inner surface, wherein the second distance is smaller than the first distance.

The shape-memory material should be understood as a material that has the ability to return from a first (deformed or temporary) state to its original state, which in the content of the present application also is referred to as the second state. The shift of state may be induced by an external stimulus or trigger, such as a change in temperature or exposure to a magnetic field, an electric field or light. Examples of shape memory materials may include shape memory alloys (SMAs), magnetic shape-memory alloys (MSMAs), such as ferromagnetic shape-memory alloys (FSMA), and shape-memory polymers.

The present invention is based on a realization that the cooling of the illumination device, i.e. the heat transfer from the light source, can be improved by reducing the distance between the light source and the envelope through which the heat dissipation is effected. The heat transfer from the light source to the surroundings via the envelope can be described by means of three mechanisms—heat convection, heat conduction and heat radiation. Convection should be understood as transfer of heat by the movement of fluid within the envelope, such as e.g. a flow of air or helium, whereas conduction should be understood as transfer of heat caused by direct interaction of neighboring atoms and molecules and does hence not necessarily require a flow of fluid. Heat radiation is a third mechanism in which the heat may be transferred by electromagnetic radiation rather than interaction with neighboring atoms or molecules. Heat radiation is believed to have a relatively small contribution to the total heat transfer at the relatively low temperatures of light sources such as LEDs. As heat transfer by conduction through an ambient medium may increase with the reciprocal distance to the inner surface portion of the envelope, heat transfer by conduction can be regarded as the dominating mechanism at relatively small distances between the light source and the inner surface portion of the envelope. Consequently, heat transfer by convection may be the predominant mechanism at larger distances. In the context of the present application, a relatively small distance should be regarded as a distance being equal to or less than the accumulated thickness of thermal boundary layers of the light source and the envelope, respectively.

The present aspects are advantageous in that the distance between the light source and the inner surface portion can be reduced so as to reduce the thermal resistance of the illumination device and hence improve the efficiency of the heat transfer. Importantly, the positioning member, which can be shifted from the first state to the second state, allows for the light source to be moved further towards the envelope after mounting, i.e. after the light source and positioning member have been assembled with the envelope. In other words, the light source can be inserted into the envelope at one point in time, and positioned closer to the inner surface portion of the envelope at a later point in time, i.e. by using an external trigger such as a source of heat, or by means of heat generated by the light source during operation. The trigger may further be realized by means of light, a magnetic field or an electric field exceeding a predetermined field strength.

Furthermore, the first and the second state of the positioning member can be adapted to suit different conditions or purposes. The first state can e.g. be adapted for facilitating the mounting of the light source, or the manufacturing process, whereas the second state can be adapted for improving the thermal operation of the illumination device. During the mounting, the positioning member may be relatively small and compact so as to facilitate insertion centrally into the envelope via a neck or opening end of the said envelope. In the second state, the positioning member may be expanded such that the light source is arranged closer to the inner surface portion of the envelope as compared with the first distance in the first state. The illumination device may therefore advantageously be adapted both to operation conditions, wherein heat transfer is of great interest, and to the manufacturing process wherein facilitation of mounting and handling is in focus.

The positioning member being adapted to shift from the first state to the second state in response to a trigger such as temperature threshold value or a threshold of field strength, advantageously allows for the light source to be moved towards the surface portion of the envelope without the need for any mechanical interventions. The envelope can therefore be sealed or hermetically closed prior to the light source being positioned at the second distance, i.e. being moved towards the inner surface portion of the envelope.

The shifting from the first state to the second state further allows for the illumination device to be cooled by means of the envelope, and hence without using any additional heat sinks or dissipating units. Dissipating the heat via the already existing envelope allows for a relatively small and compact illumination device, especially compared with illumination devices having a separate thermal path via an external and/or additional heat sink.

The positioning member may be realized as a mechanical support for the light source to which it may be directly or indirectly connected. The positioning member may e.g. be fixedly mounted to the envelope, or at least in relation to the envelope, so as to provide an accurate and reliable positioning of the light source within the envelope. The positioning member may e.g. be mounted in a stem, such as a glass stem, that is fixedly attached to the envelope by means of e.g. gluing or melting.

In the present specification, the term “state” should be understood as the positioning member having a certain shape or constitution, wherein the light source is positioned at a certain distance from the inner surface portion of the envelope. The first state may e.g. refer to the positioning member being compressed by bending, coiling or kinking. Consequently, the second state may refer to the decompressed positioning member, or at least to the positioning member being less compressed.

Further, the term “shift” refers to the transition from the first state to the second state or vice versa. In other words, the act of decompressing, expanding, uncoiling, or straightening the positioning member, such that the light source is moved closer to a wall of the envelope, should be understood as a shift of state. The act of shifting may be initiated at the transition temperature or predetermined magnetic field strength, and/or completed at said temperature or field strength.

The envelope may comprise a transparent and/or translucent material, such as e.g. a polymeric or a ceramic material, and may e.g. be injection molded. Additionally, or alternatively, the envelope may comprise Ga—La—S (GAL) glass. The envelope may further be gastight (impervious to gas), or at least having a relatively low gas transmission therethrough. The envelope may further be hermetically sealed so as to maintain a desired atmosphere within the envelope and/or to protect the light source from environmental influence. The envelope may be coupled to the positioning member by various joining methods wherein, e.g., metal is joined to metal or ceramic, or wherein ceramic is joined to ceramic, in order to obtain a hermetic, i.e. a relatively gastight, seal between the positioning member and the envelope. This may be achieved by applying an additive at the joint or junction, where the additive for example comprises metals (e.g., solder), ceramics, or glass (e.g., frit).

Further, the envelope may have relatively high thermal conductivity which advantageously may enable good heat dissipation, or cooling, of the enclosed atmosphere and/or the light source. Further, the envelope may comprise a light reflecting region arranged to reflect at least part of the light generated by the light source, and/or phosphor layer (or volume) arranged to convert at least part of the generated light to other colors.

According to an embodiment, the positioning member in its first state is introducible into the envelope via an opening end or neck of said envelope. The opening end may have a width, such as a diameter, that is smaller than a width measured at the inner surface portion of the envelope. In other words, the light source may, during manufacturing or assembly of the illumination device, be positioned possibly centrally within the envelope at the first (larger) distance from the inner surface portion of the envelope. The relative position of the light source and the envelope may be maintained e.g. by rigidly securing the positioning member to the envelope. The positioning member may after insertion into the envelope be shifted into its second state, in which it may be too wide or bulky to pass through the neck of the envelope.

According to an embodiment, the envelope has a shape conforming to the shape of a traditional light bulb. The light bulb-shaped envelope may e.g. be used for providing a retrofit illumination device for replacing in particular incandescent light sources, or other light sources such as fluorescent or high intensity discharge light sources, of luminaires already in use.

According to an embodiment, the positioning member is adapted to shift from the first state to the second state by expanding in a lateral direction of the envelope, perpendicular to its length direction. The length direction may correspond to the direction of insertion of the positioning member, i.e. the length extension from the opening end of the envelope towards its top portion, whereas the lateral direction should be understood as a direction running side to side of envelope, rather than lengthwise. In the present embodiment the light source and the positioning member can be inserted in its first, relatively compact state. The light source can then, once mounted in the envelope, be moved laterally towards the inner surface portion as the positioning member assumes its second, expanded state.

In one embodiment, the shape memory material include a shape memory alloy (SMA) or a magnetic shape-memory alloy (MSMA), such as a ferromagnetic shape-memory alloy (FSMA). Examples of FSMA include Ni₂MnGa, and examples of SMA include copper-aluminum-nickel and nickel-titanium (NiTi) alloys.

The positioning member may e.g. be formed of a wire-shaped, rod-shaped or plate-shaped material or a band shaped strip. Further, the positioning member may be formed as a spring, such as e.g. a coil spring, a helix spring or a flat spring. A spring-shaped positioning member may advantageously be deformed to into a compressed state, from which it may return to the decompressed second state upon exposure to the external stimulus such as a change in temperature or magnetic field. The shape-memory material may e.g. have a transition temperature in the range of room temperature (typically 15-25° C. or about 20° C.) to 200° C., preferably in the range of 50-150° C. and most preferred 70-100° C. The shape-memory material may also be electrically conductive, which allows the positioning member to be used for supplying electrical power to the light source.

The envelope may advantageously enclose an inert gas or atmosphere comprising e.g. helium, hydrogen, neon or nitrogen, which may protect the light source from being deteriorated and hence increase the life time of the illumination device. Alternatively, or additionally, the enclosed atmosphere may further comprise oxygen, which e.g. may be mixed with one or several of the above mentioned inert gases. The inventors have carried out studies that indicate that atmospheres comprising oxygen may further increase the cooling, and hence the life time, of light sources such as LEDs. A further advantage of helium and other low density gases such as e.g. hydrogen is their relatively high thermal conductivity which hence may improve the thermal performance of the illumination device, and in particular the heat transfer by conduction.

In one embodiment, the envelope is filled with an air atmosphere. Such atmosphere may facilitate the mounting of the positioning member, since the mounting may be performed in ambient air. Using an air atmosphere within the envelope may further reduce the requirements of the envelope being gastight, as a gas transmission through the envelope may be accepted. The material costs may thereby be lowered and the manufacturing process facilitated.

According to an embodiment, the positioning member is adapted such that the second distance is less than the accumulated thickness of the thermal boundary layer at the inner surface portion of the envelope and the thickness of the thermal boundary layer at the light source. This advantageously allows for the heat to be transferred mainly by conduction. A thermal boundary layer should be understood as a layer adjacent to the heat radiating surface, such as the inner surface portion or the light source, in which layer there is a temperature gradient between the heat radiating surface and the ambient medium (or enclosed atmosphere). In other words, the thermal boundary layer may be defined as the layer of medium between the freely flowing medium and the surface to be cooled.

In one embodiment, the second distance is 20 mm or less. In case of an air atmosphere inside the envelope, the second distance may advantageously be 5 to 8 mm or less which may further improve the heat transfer. The inventors have carried out studies that indicate that the effective thermal boundary layer at the light source may be 1 to 4 mm for an air atmosphere and 3 to 10 mm for a helium atmosphere, which may present a lower thermal resistance. At the inner surface portion of the envelope, the effective thermal boundary layer may be at least 3 mm for an air atmosphere and at least 8 mm for a helium atmosphere. A second distance of 15 mm or less may hence advantageously be used with a helium atmosphere, whereas a second distance of 5 mm or less may be used with an air atmosphere. The efficiency of the heat transfer may be increased with a decreasing second distance, whereas the risk of damages caused by mechanical contact between the light source and the inner surface portion of the envelope during insertion may be reduced with a relatively large first distance.

The light source is typically a solid state light source and may comprise one or several light emitting diodes (LEDs). However, the term “light source” may refer to any device or element that is capable of emitting radiation in any region or combination of regions of the electromagnetic spectrum, for example the visible region, the infrared region, and/or the ultraviolet region, when activated e.g. by applying a potential difference across it or passing a current through it. Therefore, a light source can have monochromatic, quasi-monochromatic, polychromatic or broadband spectral emission characteristics. Examples of light sources include semiconductor, organic, or polymer/polymeric LEDs, blue LEDs, optically pumped phosphor coated LEDs, optically pumped nano-crystal LEDs or any other similar devices as would be readily understood by a person skilled in the art.

The term “light source” (or “LED filament”) may further refer to a substrate, such as a glass or translucent ceramics substrate, on which LEDs may be arranged in an array. The LEDs may be electrically connected to the substrate by means of electrical tracks and bond wires. A phosphor layer may be deposited on top of the LEDs so as to convert at least some of the emitted light into a desired color, such as e.g. yellow. A phosphor layer may also be provided on the substrate, such as e.g. a back side of the substrate, thereby allowing light transmitted through the substrate to be color converted.

It is noted that embodiments of the invention relates to all possible combinations of features recited in the claims. Further, it will be appreciated that the various embodiments described for the lighting assembly are all combinable with embodiments of the method as defined in accordance with the second aspect.

### BRIEF DESCRIPTION OF THE DRAWINGS

These and other aspects will now be described in more detail with reference to the appended drawings showing embodiments.

FIGS. 1a and b show cross sectional sides views of an illumination device according to an embodiment.

FIGS. 2a and b show cross sectional top views of a similar embodiment as shown in FIGS. 1a and b.

FIGS. 3a and b illustrate a top view of a positioning member according to an embodiment.

FIGS. 4a and b illustrate a top view of a positioning member according to a further embodiment.

FIG. 5 schematically outlines a method for manufacturing an illumination device according to an embodiment.

All the figures are schematic, not necessarily to scale, and generally only show parts which are necessary in order to elucidate the embodiments, wherein other parts may be omitted or merely suggested Like reference numerals refer to like elements throughout the description.

### DETAILED DESCRIPTION

The present aspects will now be described more fully hereinafter with reference to the accompanying drawings, in which currently preferred embodiments are shown. This invention may, however, be embodied in many different forms and should not be construed as limited to the embodiments set forth herein; rather, these embodiments are provided for thoroughness and completeness, and fully convey the scope of the present aspects to the skilled person.

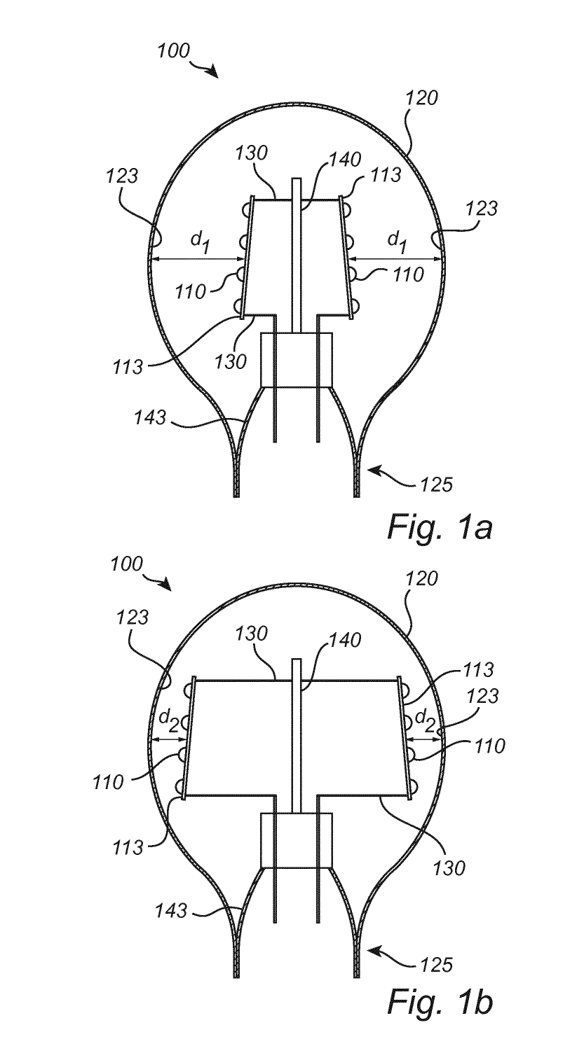

FIGS. 1a and b show an illumination device according to the invention. In FIG. 1a the positioning member is arranged in its first state and in FIG. 1b it is arranged in its second state.

The illumination device comprises a light source, such as LEDs 110, an envelope 120, and a positioning member 130. The illumination device according to the embodiment of FIGS. 1a and b further comprise a holder 140, a stem 143 and an opening 125 of the envelope 120.

The LEDs 110 may be mounted on a support, e.g. on a printed circuit board, PCB, which may provide electrical power supply and mechanical support to the LEDs 110. The embodiment shown in FIGS. 1a and b comprises two oppositely arranged PCBs 113 having a plurality of LEDs 110 and being attached to the holder 140 by means of the positioning member 130. The holder 140 may be mounted on the stem 143, such as a glass stem 143, and may extend in a vertical direction parallel to a length axis of the envelope, i.e. in a direction extending from the bottom opening 125 of the envelope towards the top opposing top of said envelope 120. The holder 140, the positioning member 130 and the light source 110 may be centrally arranged within the envelope 120, i.e. arranged along the length axis of the envelope 120.

The positioning member 130 may be structurally arranged between the PCBs 113 and the holder 140 and adapted to position the PCBs 113, and hence the LEDs 110, at a desired location within the envelope 120. In the first state of the positioning member 130 the light source 110 may be arranged relatively close to the central length axis as compared with the second state in which it has been moved closer to an inner surface portion 123 of the envelope 120. FIG. 1a illustrates the position of the LEDs 110 in at a first distance d₁ from the respective inner surface portion 123 of the envelope 120, whereas FIG. 1b shows the LEDs 110 positioned at a second distance d₂ from said inner surface portions 123.

The envelope may e.g. be formed as a glass bulb adapted to at least partly enclose the LEDs 110. The inner surface portions 123 are arranged to face the respective LEDs 110 in their mounted position. The positioning member 130, to which the LEDs 110 and the PCBs 113 are attached, may assume a first, compressed state and a second, expanded state. In the first state the LEDs 110 may be positioned relatively close to the holder as compared with their position in the second state. Consequently, the first distance d₁ between the LEDs 110 and the respective inner surface portion 123 of the envelope 120 may be reduced to the second distance d₂ as the positioning member shifts from the first state to the second state.

In this embodiment, the total lateral extension of the LEDs 110, PCBs 113 and the positioning member 130 in the first state may be smaller than the opening or neck 125 of the envelope 120 and these components may hence be inserted through said opening 125 during assemblage of the illumination device 100. The distance d₁ may further reduce the risk for the LEDs 110 or the positioning member 130 to touch the envelope 120 during insertion and hence reduce the risk for causing mechanical damage to the envelope 120, any of the LEDs 110 and/or the positioning member 130 during insertion.

Once the LEDs 110, PCBs 113 and positioning member 130 have been inserted, the opening 125 of the envelope 120 may be sealed, e.g. by welding or gluing to the holder 140 or the glass stem 143 so as to provide and maintain a desired atmosphere within the envelope 120. The atmosphere may e.g. comprise an inert gas, such as helium, neon or nitrogen, or oxygen and/or gas mixtures such as air.

In FIG. 1b the positioning member 130 is illustrated in the second state. The distance between the LEDs 110 and the inner surface portion 123 is reduced to a second distance d₂, which is smaller than d₁. The LEDs 110 are hence moved laterally towards the inner surface portion 123 of the envelope 120 during the shift from the first state to the second state of the positioning member 130. The LEDs 110 are thereby positioned closer to the inner surface portion 123 of the envelope 120 in the second state than in the first state of the positioning member 130, which thereby may increase the efficiency of the heat dissipation.

The positioning member 130 may, according to the present embodiment, comprise a wire 130 formed of a shape memory material, such as a shape memory alloy (SMA) or a ferromagnetic shape memory alloy (FSMA). The wire 130 may in its first state be curved, or bent, in one or several directions, which will be discussed in more detail below. The SMA may have a transition temperature, above which the SMA may start to shift from its deformed first state to its original state, non-deformed state. Similarly, in case of a FSMA is used, the wire 130 may, upon exposure to a magnetic field having a field strength exceeding a predetermined threshold value, resume its second, non-deformed original state. Examples of SMAs include copper-aluminum-nickel and nickel-titanium (NiTi) alloys.

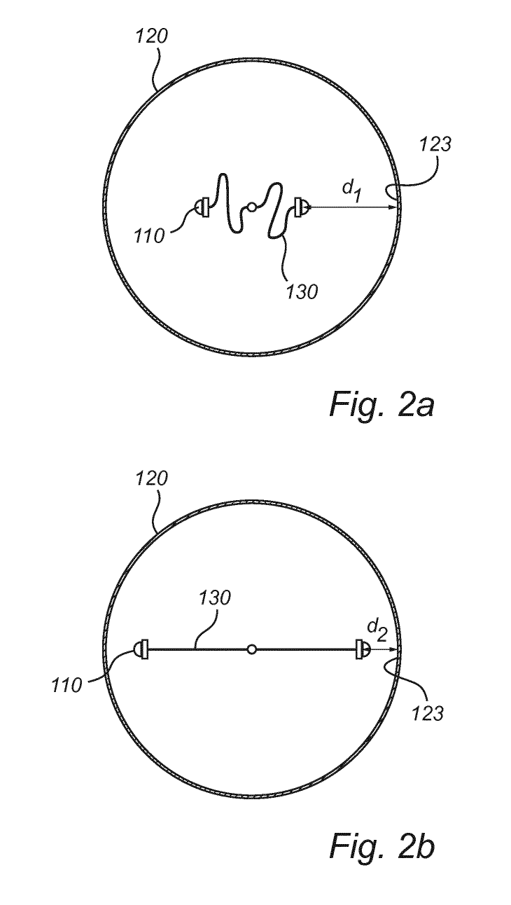

FIGS. 2a and b are cross sectional a top views of a portion of a similar illumination device as described with reference to FIGS. 1a and b. The cross section is taken along a lateral width of the envelope 120 and illustrates the relative positions of the envelope 120, the LEDs 110 and the positioning means 130. The positioning member 130 may, according to the present embodiment, be formed of a flat strip of material that has been bent into a compressed first state which is illustrated in FIG. 2a. The positioning member 130 is hence relatively compact, i.e. has a relatively small lateral extension, and the LEDs 110 are thus positioned at the first distance d₁ from the inner surface portion 123 of the envelope 120.

In FIG. 2b, the positioning member 130 is arranged in the second state wherein the flat strip is straightened out such that the LEDs 110 are positioned closer to the inner surface portion 123 of the envelope 120. The lateral extension of the positioning member 130 is hence larger than in the first state, and the LEDs 110 are positioned at a distance d₂ from the inner surface portion 123 of the envelope 120.

It will however be realized that the positioning member 130 may not necessarily be formed of a wire-shaped material. The positioning member 130 e.g. be formed of at least one plate, rod, strip, wire, tube etc. that can be deformed into a decompressed first state and which can resume an expanded, original second state. The positioning member can e.g. be deformed into a compressed state by bending, folding, coiling, kinking or twisting. It will also be appreciated that the positioning device may be formed to support one or several light sources 110 and/or PCBs 113.

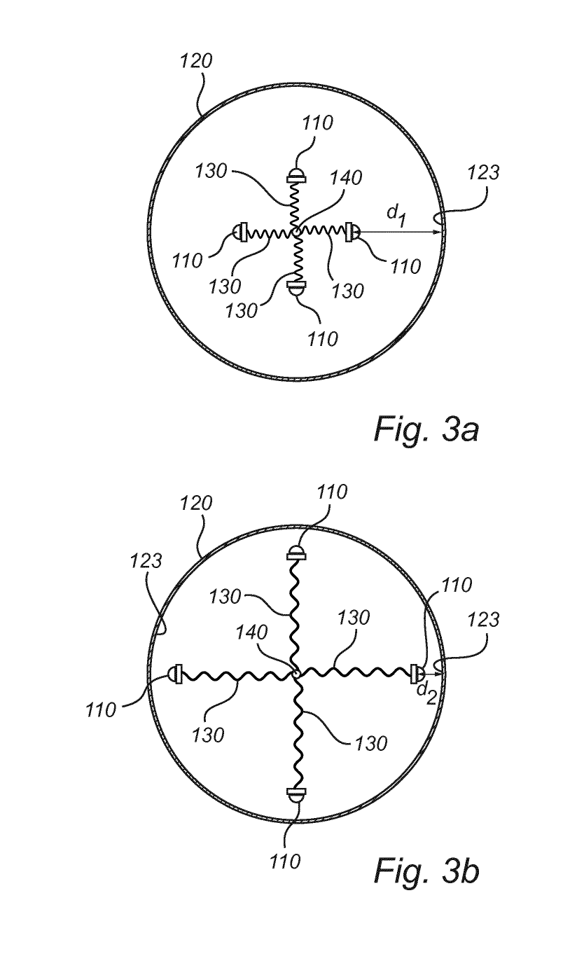

In FIGS. 3a and b a further example of a positioning member 130 according to the present invention is shown. The positioning member 130 may e.g. be formed by four coil springs attached to the holder 140 and extending in a respective orthogonal direction in a lateral plane of the illumination device 100. FIG. 3a shows the positioning member in its first state wherein the coil springs 130 are compressed such that the light sources 110 are positioned at a first distance d₁ from the inner surface portion 123 of the envelope.

The positioning member 130 may in the first state be sufficiently compressed to allow the positioning member 130 to be inserted through the opening end or neck 125 (not shown) of the envelope 120. In other words, the positioning member 130 may be formed so as to allow the LEDs 110 to be arranged sufficiently close to each other such that their total maximum lateral extension does not exceed the width of the neck 125. After the positioning member 130, and hence the LEDs 110, are positioned within the envelope 120, the positioning member may be exposed to an external trigger so as to enable it to return from its first state to its original, second state. In case the positioning member 130 is formed of a SMA, it may be heated to a temperature exceeding the transition temperature. The transition temperature may e.g. be included in the interval between room temperature and 200° C. or lower, such as in the range of 70° C. and 100° C. In case the positioning member 130 is formed of a FSMA, it may be exposed to a magnetic field.

FIG. 3b shows the positioning member 130 in the second state wherein the LEDs 110 are arranged at the second, smaller distance d₂ from a respective inner surface portion 123 of the envelope 120. Even though all four LEDs 110 depicted in FIG. 3b appear to be arranged at the same distance d₂, it will however be realized that they may be arranged at different distances from the respective inner surface portion 123 of the envelope 120. The first and second distances d₁ and d₂ should, in the context of the present application, be understood as the distance between at least one light source 110 and the inner surface portion 123 located closest to said light source 110.

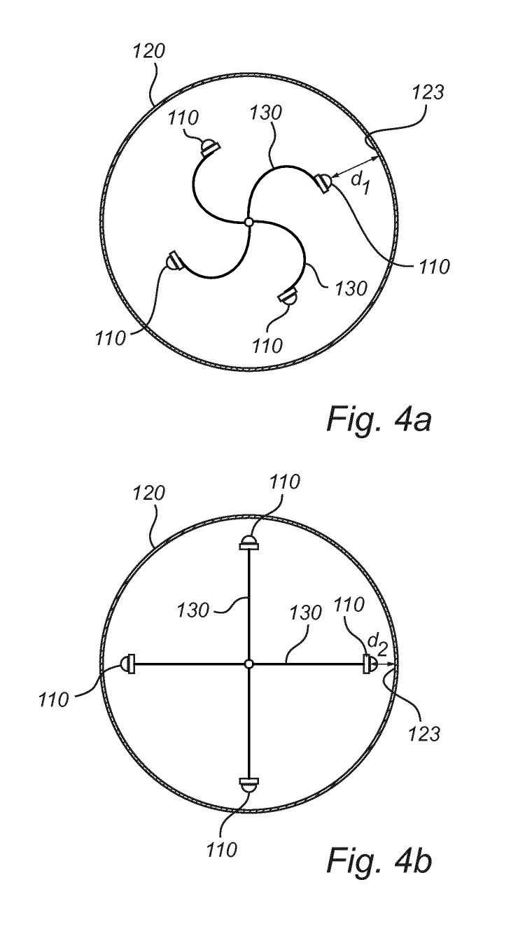

FIGS. 4a and b illustrate a cross sectional top view of another embodiment of an illumination device 100 similar to the embodiments described with reference to the previous figures. The positioning member 130 of the present illumination device 100, however, is formed of two plate-like structures extending in a plane parallel to the length axis of the illumination device 100. The plate-like structures are in their first state curved such that they forms two intersecting S-shaped cross sections as shown by the top view illustrated of FIG. 4a. In its second state, which is shown in FIG. 4b, the positioning member 130 may be straightened out such that the both plate-like structures conform to the shape of a respective linear plane, rather than the curved planes of FIG. 4a. The light sources 110, such as e.g. LEDs 110, that are supported by the positioning member 130 may therefore be moved towards the envelope 120 such that they in the second state are arranged at a smaller distance d₂ from a respective inner surface portion 123 as compared with the first distance d₁ in the first state.

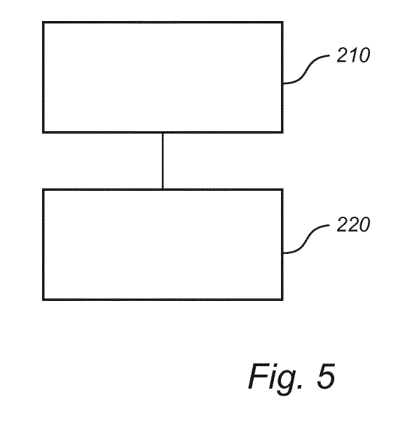

FIG. 5 schematically illustrates a method for manufacturing an illumination device, comprising the step of arranging 210 a positioning member within an envelope, wherein the envelope is adapted to at least partly enclose a light source and the positioning member is adapted to position the light source at a first distance from an inner surface portion of the envelope, and the step of exposing 220 the shape-memory material of the positioning member to an external stimulus, such as a temperature or magnetic field exceeding a predetermined threshold value such that the positioning member shifts to a second state in which the light source is positioned at a second distance from the inner surface, wherein the second distance is smaller than the first distance.

In conclusion, an illumination device is provided. The illumination device comprises a light source which is at least partly enclosed by an envelope can be positioned within the envelope by means of a positioning member. The positioning member is arrangeable to assume a first state in which the light source is positioned at a first distance from an inner surface portion of the envelope and a second state in which the light source is positioned at a second distance from the inner surface portion. The second distance is smaller than the first distance so as to allow for an increased transfer of heat from the light source. The positioning member comprises a shape-memory material that is adapted to shift the positioning member from the first state to the second state upon exposure to an external stimulus, such as a temperature or magnetic field exceeding a predetermined threshold value. The light source may thereby be moved towards the inner surface portion of the envelope after the illumination source has been assembled.

The person skilled in the art realizes that the present invention by no means is limited to the preferred embodiments described above. On the contrary, many modifications and variations are possible within the scope of the appended claims. For example, the positioning member may be electrically conductive so as to supply the light source with electrical power, or electrically insulating to as to prevent the light source and/or illumination device from electrical shortcuts. The light source may e.g. be supplied with electrical power by means of electrical connectors that are separately formed from the positioning device and/or the holder.

Additionally, variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

1. An illumination device, comprising:
a light source adapted to emit light;
an envelope adapted to at least partially enclose the light source;
a positioning member adapted to position the light source within the envelope; wherein:
the positioning member is arrangeable to assume a first state in which the light source is positioned at a first distance from an inner surface portion of the envelope and a second state in which the light source is positioned at a second distance from the inner surface portion, the second distance being smaller than the first distance; and
the positioning member comprising a shape-memory material adapted to shift the positioning member from the first state to the second state as the shape-memory material is exposed to an external stimulus.

2. The illumination device according to claim 1, wherein the positioning member in its first state is introducible into the envelope via an opening end of said envelope.

3. The illumination device according to claim 2, wherein the opening end of the envelope has a width that is smaller than a width measured at the inner surface portion of said envelope.

4. The illumination device according to claim 1, wherein the envelope has a shape conforming to the shape of a light bulb.

5. The illumination device according to claim 1, wherein the light source is a solid state light source.

6. The illumination device according to claim 1, wherein the positioning member is adapted to shift from the first state to the second state by expanding in a lateral direction of the envelope.

7. The illumination device according to claim 1, wherein the shape-memory material is a shape memory alloy, SMA, or a ferromagnetic shape memory alloy, FSMA.

8. The illumination device according to claim 1, wherein the positioning member is formed of a wire-shaped material.

9. The illumination device according to claim 1, wherein the positioning member is formed as a spring.

10. The illumination device according to claim 1, wherein the envelope is filled with a gas comprising helium.

11. The illumination device according to claim 1, wherein the envelope is filled with air.

12. The illumination device according to claim 1, wherein the second distance is less than the sum of the thickness of a thermal boundary layer at the inner surface portion and the thickness of a thermal boundary layer at the light source.

13. The illumination device according to claim 1, wherein the positioning member is adapted such that the second distance is 15 mm or less.

14. A method for manufacturing an illumination device, the method comprising:
arranging a positioning member within an envelope, the envelope being adapted to at least partly enclose a light source and the positioning member being adapted to position said light source at a first distance from an inner surface portion of the envelope;
exposing a shape-memory material of the positioning member to an external stimulus such that the shape-memory material shifts the positioning member to a second state in which the light source is positioned at a second distance from the inner surface, the second distance being smaller than the first distance.
